(19) United States
(12) Patent Application Publication
(10) Pub. No.: US 2018/0104754 A1
(43) Pub. Date: Apr. 19, 2018

(54) APPARATUS AND METHOD FOR BEVEL GEAR RETRACTABILITY

(71) Applicant: Klingelnberg AG, Zürich (CH)

(72) Inventor: Rudolf Houben, Hückeswagen (DE)

(21) Appl. No.: 15/784,645

(22) Filed: Oct. 16, 2017

(30) Foreign Application Priority Data
Oct. 17, 2016 (DE) 102016119717.3

(51) Int. Cl. B23F 17/00; B23F 23/10; B24B 53/085; B23F 19/00

(52) U.S. Cl. CPC B23F 17/001; B23F 23/10; B23P 15/14; B23F 19/00; B24B 53/085

(57) ABSTRACT

Methods and apparatuses enabling/improving retractability of a first bevel gear that with at least one second bevel gear forms a transmission, performing:
a retractability analysis including:
   ascertainment whether during the installation in a housing the first gear can be engaged by an axial insertion movement with the second gear and/or the first gear can be separated from the engagement with the second gear by an axial retraction movement, and
   if a collision results during the engagement or separation between teeth of the gears
      ascertainment of a flank modification of the teeth of the first and/or second gears to avoid the collision,
      ascertainment of second machine data of based on this modification, and
finish machining in a bevel gear cutting machine to perform the flank modification according to the second machine data on the teeth of the respective gears.

### CROSS REFERENCE TO RELATED APPLICATIONS

This application claims priority under 35 U.S.C. §§ 119(a)-(d) to German patent application no. DE102016119717.3 filed Oct. 17, 2016, which is hereby expressly incorporated by reference as part of the present disclosure.

### FIELD OF INVENTION

The present invention relates to the retractability of bevel gears in a bevel gear transmission. In addition, it relates to a device, which comprises a gear cutting machine and a correspondingly equipped development environment. In addition, it relates to a correspondingly modified bevel gear transmission.

### BACKGROUND

There are various types of bevel gear transmissions. Each of these bevel gear transmissions comprises at least two bevel gears, which are mutually engaged with one another. Bevel gear transmissions are also referred to as angular transmissions, since the rotational axes of the two bevel gears are at an angle to one another.

FIG. 1 shows details of an exemplary (bevel gear) transmission 10 in a perspective view, as is used, for example, in a crusher. The housing of this transmission 10 is not shown here. Two bevel gears 20, 30 are used, which are installed in the housing (not shown) in such a manner that they are engaged. The first bevel gear 20 (a pinion here) is seated on a shaft 21 and the second bevel gear 30 (a crown wheel here) is seated on a shaft 31. The spiral teeth 22 of the first bevel gear 20 and the spiral teeth 32 of the second bevel gear 30 can be seen in FIG. 1.

FIG. 2 shows details of a similarly constructed (bevel gear) transmission 10 in a side view. This depiction is very schematic. A rectangular housing 11 is used, in which two bevel gears 20, 30 are installed so that they are engaged. An installation/inspection opening can be provided laterally on the housing 11, for example, which is closed oil-tight here using a plate 12 and a suitable seal (not shown). During the installation, firstly the second bevel gear 30 can be introduced through the installation/inspection opening into the housing 11 and screwed together or plugged together therein, for example, with a stub shaft or a shaft 31. The first bevel gear 20 is then inserted in the axial direction, i.e., parallel to the first shaft 21, through the installation/inspection opening into the housing 11, wherein it is ensured that the teeth of the first bevel gear 20 are cleanly engaged with the teeth of the second bevel gear 30. The corresponding bearings and seals for the shafts 21, 31 are not shown here. After the mentioned installation steps, oil can be poured in and the plate 12 including the seal can be fastened on the housing 11.

The removal is typically performed in the reverse sequence of the steps mentioned by way of example.

Both during the installation and during the removal, a collision of the teeth of the two bevel gears can occur. Such a collision occurs above all in the case of helical-toothed and spiral-toothed bevel gears. In practice, a hammer is sometimes used when inserting the first bevel gear 20, in order to overcome the mechanical resistance which can result due to such a collision, even if this procedure is not technically correct. Using an angle grinder is also known, for example, to remove parts of the tooth flanks on one or two teeth of the first bevel gear 20, so that they no longer collide and jam during the insertion.

It is obvious that such approaches have disadvantages. Flexing or grinding away parts of a tooth flank results in weakening of this tooth. The possibility for load transmission from one to the other bevel gear is thus reduced. Cracking and failure of the affected tooth can occur here. Furthermore, the removal of material on one or two teeth results in an imbalance, which can in turn have an influence on the quiet running.

Even if no further problems should occur after the flexing or grinding away during the insertion of the first bevel gear 20, since it can be ensured during the insertion that the first bevel gear 20 having the modified tooth/teeth is exactly engaged with the tooth gaps of the second bevel gear 30 in a suitable angle position, the separation (also called pulling) of the two bevel gears 20, 30 can nonetheless be difficult or even impossible, if one does not find the same angle position again.

To avoid the mentioned problems during the installation or during the pulling of bevel gears of a bevel gear transmission, the retractability can be taken into consideration from the outset in the design of the transmission. It is sometimes possible to avoid the jamming from the outset by way of a small adaptation of the macro-geometry of the two bevel gears of the bevel gear transmission. If, for example, the tooth flanks extending in a spiral should have an excessively small radius of curvature, a gear cutting tool having a larger tool nominal radius can thus be used during the gear cutting. The larger nominal radius results in a less strongly curved profile of the tooth flanks and therefore also in a lesser tendency toward jamming. In the case of large-module bevel gears, as are used in stone mills and the like, however, gear cutting tools having a sufficiently large tool nominal radius are not available. In addition, such changes of the macro-geometry often have to be “traded off” against a reduced degree of overlap and, because of this, also a reduced carrying capacity.

Situations therefore occur again and again in which the retractability does not enable an adaptation of the macro-geometry or in which the adaptation of the macro-geometry determined by computer is undesirable.

### SUMMARY

It is an object of the invention therefore to find a way which reliably enables the retractability of two bevel gears during the separation thereof, without having to depend on manual re-machining.

According to at least some embodiments, a method enables or improves the retractability of a first bevel gear, which is configured to form a transmission together with at least a second bevel gear, wherein the transmission is installed in a housing in such a way that a rotational movement of the first bevel gear can be transferred into a rotational movement of the second bevel gear, or vice versa.

According to at least some embodiments, the method comprises the following steps:
(I) carrying out a retractability analysis having the following partial steps:
   (A) determining with a computer whether, during installation into the housing, the first bevel gear can be engaged by an axial insertion movement with the second bevel gear and/or whether the first bevel gear can be separated by an axial pulling movement from the engagement with the second bevel gear,
   (B) if the computer predicts a collision during the engagement or during the separation between a tooth of the first bevel gear and a tooth of the second bevel gear,
      (i) determining with a computer a flank modification on the teeth of the first or the second bevel gear to avoid the collision, and
      (ii) determining of second machine data on the basis of this flank modification,
(II) carrying out gear cutting machining in a bevel gear cutting machine, to provide the first or the second bevel gear with gear teeth according to first machine data; and
(III) carrying out finish machining in the bevel gear cutting machine, to perform the flank modification according to the second machine data on the already provided teeth of the first or the second bevel gear.

The finish machining in the bevel gear cutting machine can be performed as continuous indexing finish machining or discontinuous indexing finish machining (also called the single indexing method).

Design data for the first or the second bevel gear may be provided in a preparatory method step, which is performed before an ascertainment of the first machine data, wherein the first machine data are then derived from these design data.

The preparatory method step may be carried out in a development environment, which is equipped with software for designing a transmission.

The development environment may comprise a computer which is equipped with software for designing transmissions.

In some at least embodiments, a (total) device comprises a CNC-controllable gear cutting machine and a development environment, wherein the development environment can be brought into a communication connection with the gear cutting machine. The gear cutting machine comprises a CNC controller and multiple CNC-controlled axes, and is configured to manufacture a bevel gear with gear teeth on the basis of machine data with a continuous gear cutting procedure. The (total) device may comprise the following features:
(a) the development environment is equipped with software for designing a transmission having a first bevel gear and a second bevel gear to be paired therewith, in order to provide design data for the first and/or the second bevel gear with this design;
(b) the development environment is designed for carrying out a retractability analysis, to determine by computer a flank modification on the teeth of the first or the second bevel gear with this retractability analysis, in order to avoid a collision of the teeth of the first bevel gear with teeth of the second bevel gear during the installation or removal, and
(c) the development environment provides second machine data when carrying out the retractability analysis, which are usable in the gear cutting machine for the CNC-controlled finish machining of the teeth of the first or the second bevel gear.

At least some embodiments enable partially automated machining of at least one bevel gear of a bevel gear transmission, to improve or enable the retractability thereof.

According to at least some embodiments, the penetration region is removed in a targeted and highly accurate manner by a cutting finish machining procedure by means of modified machine (setting) data (called second machine data here). In at least some such embodiments, a continuously running milling or grinding procedure may be used as the cutting finish machining procedure.

The finish machining which is used for the flank modification can be used, for example, on the thrust flanks of crown wheels, if the transmission is only to be used in traction operation.

An advantage of at least some embodiments is that they supply reproducible and reliable results. A bevel gear transmission which was improved/optimized using embodiments of the invention with respect to the retractability on all teeth of one of the bevel gears does not display any imbalance, as is the case in bevel gear transmissions in which one of the bevel gears to be paired was manually finish machined.

It is an advantage of at least some embodiments that reproducible finish machining results, because it is measurable.

Since the finish machining was applied to all right and/or all left flanks of one of the two bevel gears, the retractability is provided in any arbitrary engagement position of the wheel set.

At least some embodiments have the advantage that when carrying out the retractability analysis, the carrying capacity of the teeth can be taken into consideration, to thus avoid excessively strong local weakening of the teeth.

At least some embodiments have the advantage that even in the case of large and heavy bevel gear transmissions, the bevel gear pinion can be axially pulled during a removal, without an axial (lowering) movement of the crown wheel being necessary.

At least some embodiments are usable both in the continuous and also in the discontinuous indexing method on CNC-controlled gear cutting machines. Bevel gear milling machines and bevel gear grinding machines, which have at least five CNC-controlled axes, are particularly suitable.

The finish machining for the purpose of flank modification can be carried out according to at least some embodiments on the soft bevel gear (i.e., before the hardening) or on the hardened bevel gear.

At least some embodiments are suitable for industrial transmissions and for transmissions which are distinguished by a high carrying capacity and for transmissions which have a module >10.

### BRIEF DESCRIPTION OF THE DRAWINGS

The figures will be described in a connected and comprehensive manner. Exemplary embodiments will be described in greater detail hereafter with reference to the drawings.

FIG. 1 shows a schematic perspective view of an exemplary transmission, which is designed, for example, as part of the drive of a crusher;

FIG. 2 shows a very schematic side view of an exemplary transmission, which is installed here in a rectangular housing;

FIG. 3 shows a very schematic perspective view of a further exemplary transmission, which is installed here in a rectangular housing;

FIG. 4 shows a schematic flow chart showing steps of a method;

FIG. 5 shows a schematic flow chart having further steps of a method;

FIG. 6 shows a schematic block diagram of a (total) device;

FIG. 7 shows a schematic view of a spiral-toothed tooth of a bevel gear in radial projection, in which the penetration region is shown;

FIG. 8 shows a schematic perspective view of several spiral-toothed teeth of a bevel gear which was modified according to some embodiments of the invention (the concave thrust flanks of a crown wheel were modified in the example shown).

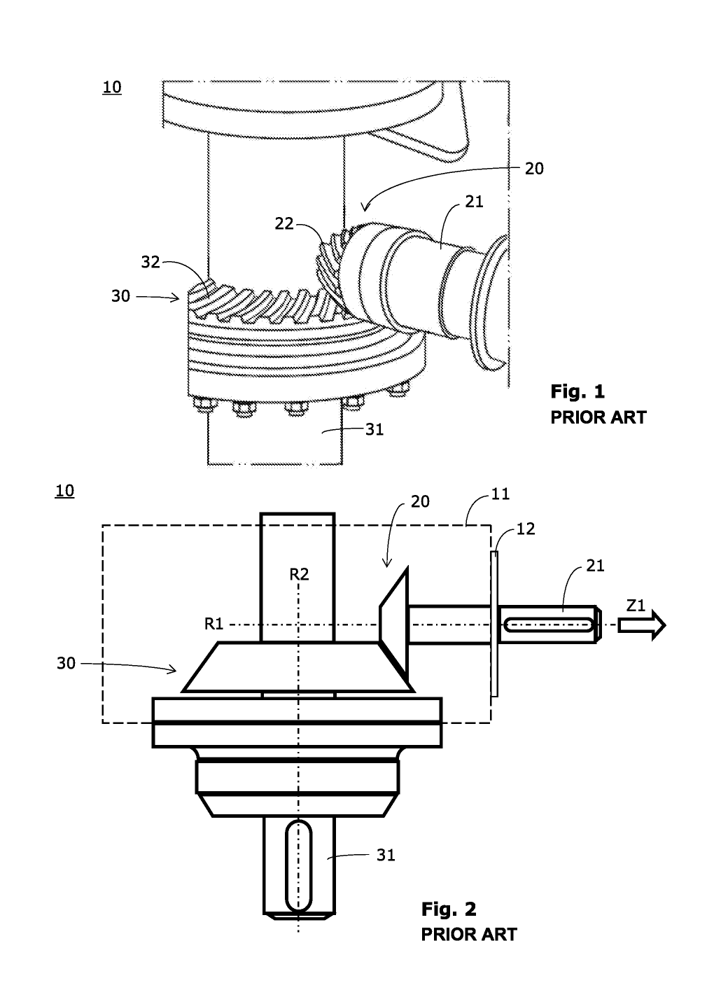

### DETAILED DESCRIPTION OF EMBODIMENTS

Terms are used in conjunction with the present disclosure which are also used in relevant publications and patents. However, it is to be noted that the use of these terms is only to serve for better understanding. The inventive concepts and the scope of protection of the patent claims are not to be restricted in the interpretation by the specific selection of the terms. The invention may be readily transferred to other term systems and/or technical fields. The terms are to be applied accordingly in other technical fields.

A superposition of rotational and traction movement is referred to as an axial traction movement. The term “axial traction movement” is to indicate that the traction movement comprises a clear axially oriented component. An “axial insertion movement” is a superposition of rotational and thrust movements.

FIG. 2 shows details of an exemplary (bevel gear) transmission 10 in a side view. This depiction is schematic. The transmission 10 comprises, as mentioned at the outset, two bevel gears 20, 30 to be paired.

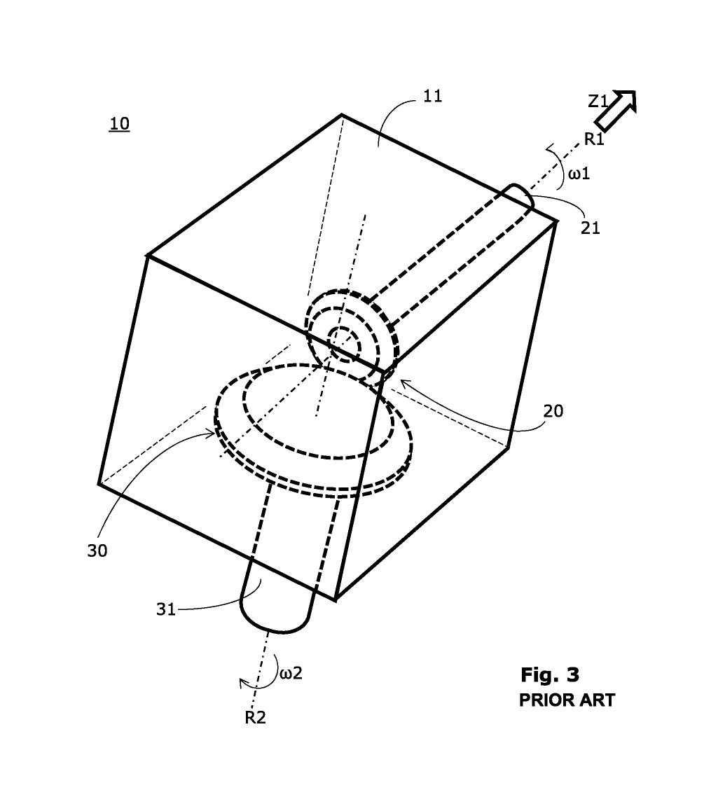

A rectangular housing 11 is used, in which the two bevel gears 20, 30 are installed (paired with one another) so that they are engaged. An installation/inspection opening can be provided laterally on the housing 11, which is closed oil-tight here using a plate 12 and a suitable seal (not shown). During a removal, firstly, the installation/inspection opening on the housing 11 is opened and the oil is (partially or entirely) drained. The first bevel gear 20 can then be pulled in the axial direction, i.e., parallel to the rotational axis R1 of the first shaft 21, out of the housing 11 through the installation/inspection opening. The pulling is shown in each of FIGS. 2 and 3 by a block arrow having the reference sign Z1. The axially oriented traction movement Z1 may be superimposed with a rotational movement, to enable separation of the two bevel gears 20, 30. The second bevel gear 30 (the crown wheel) may be rotated slightly about the rotational axis R2 while the first bevel gear 20 (the pinion) is pulled.

If the second bevel gear 30 has to be repaired or replaced, this second bevel gear 30 can thus be unscrewed and removed through the installation/inspection opening on the housing 11. The second bevel gear 30 can also be removed through another opening of the housing 11, for example, by axial lowering, which is often only feasible in the case of extremely heavy crown wheels with great effort. The installation situation also often does not enable lowering of the second bevel gear 30, i.e., the first bevel gear 20 also has to be removed by pulling in the axial direction in these cases.

If one of the bevel gears 20 or 30 was modified according to certain embodiments the invention, the pulling Z1 can thus be carried out without problems and without jamming of the teeth 22, 32 of the two bevel gears 20, 30.

FIG. 3 schematically shows a perspective view of a further exemplary (bevel gear) transmission 10. Both bevel gears 20, 30 each have a shaft 21, 31 in the example shown, the ends of which protrude out of the housing 11. If the first bevel gear 20 is rotationally driven clockwise, as shown in FIG. 3 by the arrow ω1, the second bevel gear 30 then rotates counterclockwise, as shown by the arrow ω2. The rotational direction is defined here in each case with a viewing direction along the rotational axes R1, R2.

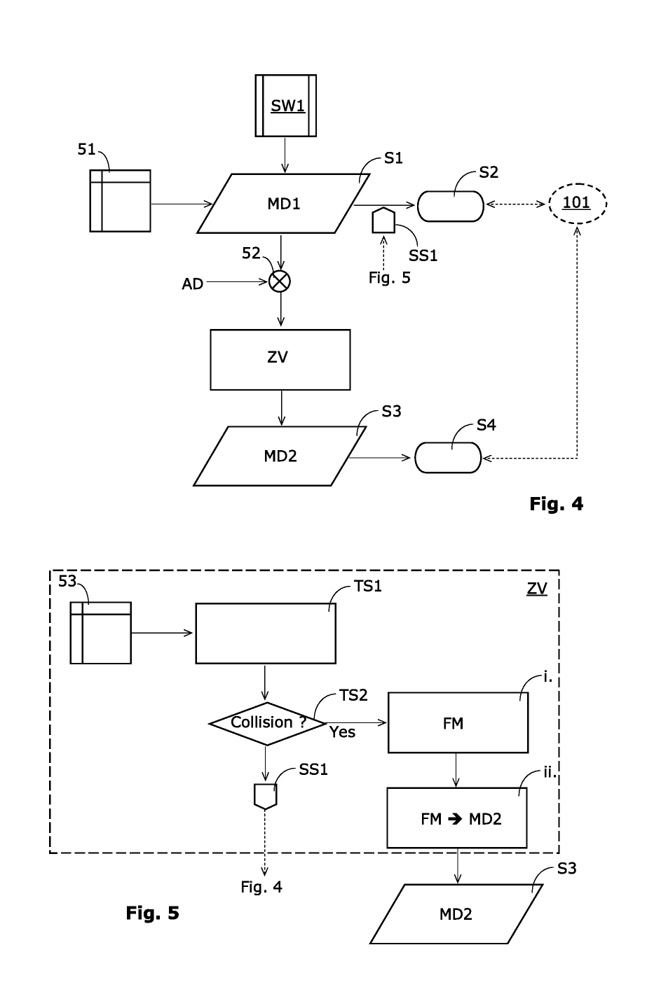

To enable or simplify the installation and removal, which was explained on the basis of multiple figures to be understood as examples, a method is described hereafter with reference to the flowcharts of FIGS. 4 and 5.

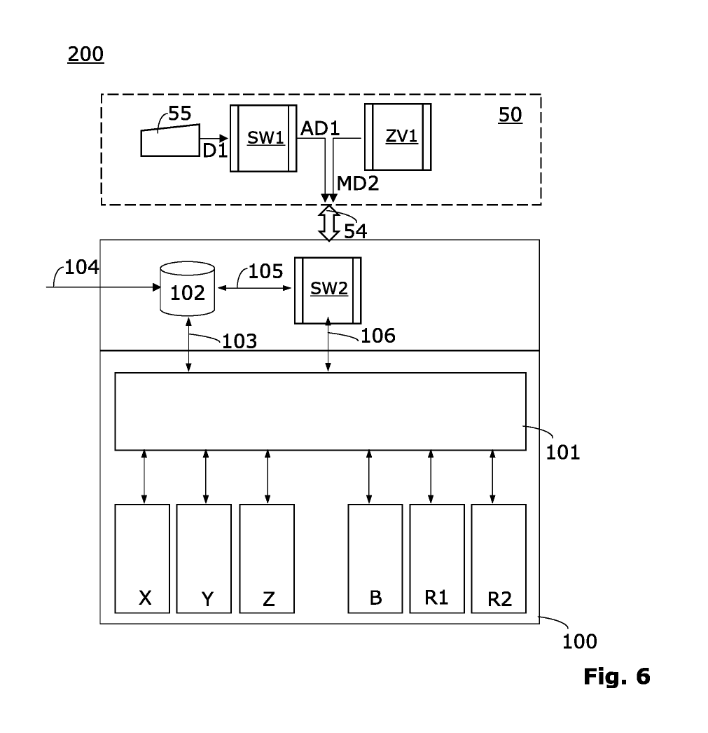

First machine data MD1 may be provided in a first step S1. These data MD1 can be loaded from a memory region 51 or provided by software SW1, for example. The machine data MD1 are used for the CNC-managed control of a bevel gear cutting machine 100 (see, for example, FIG. 6) during the gear cutting of the first bevel gear 20 or the second bevel gear 30. The individual CNC-managed movements of the axes of the bevel gear cutting machine 100 are quasi-defined in the machine data MD1.

The machine data MD1 can be transferred in an (intermediate) step to the bevel gear cutting machine 100, as indicated in FIG. 4 by the step S2. In FIG. 4, the step S2 is only shown by an interface or borderline to the CNC controller 101 of the bevel gear cutting machine 100.

A retractability analysis ZV is now carried out. The method step ZV uses either the machine data MD1, or it uses design data AD of the transmission 10. The retractability analysis ZV can also use a combination of the machine data MD1 and the design data AD, however. It is therefore indicated by a node 52 in FIG. 4 that the machine data MD1 and the design data AD can be combined.

In FIG. 4, the retractability analysis ZV is only shown as a process, which is provided with the reference sign ZV. As a result, the retractability analysis ZV supplies, in a step S3, machine data MD2 or—in another embodiment—modified first machine data MD1.

The machine data MD2, or possibly the modified first machine data MD1, can be transferred in an (intermediate) step to the bevel gear cutting machine 100, as indicated in FIG. 4 by the step S4. In FIG. 4, the step S4 is only shown by an interface or borderline to the CNC controller 101 of the bevel gear cutting machine 100.

FIG. 5 shows exemplary details of an embodiment of a retractability analysis ZV.

The retractability analysis ZV can comprise the following partial steps, for example:

In step TS1, a computer determines whether, during the installation in the housing 11, the first bevel gear 20 can be engaged by an axial insertion movement with the second bevel gear 30 and/or whether the first bevel gear 20 can be separated by an axial traction movement from the engagement with the second bevel gear 30. To be able to ascertain a collision of the two bevel gears 20, 30 during the installation or removal, the design data AD of the transmission 10 may be computer analyzed. In particular, the precise flank geometry and installation location have to be known to be able to ascertain a collision of the two bevel gears 20, 30. This means the design data AD, which are used here, should particularly contain items of information on the flank geometry and installation location. The design data AD can be loaded from a memory region 53, for example, as shown in FIG. 5. The memory regions 51 and 53 can be provided in the same memory (for example, in the memory 102 shown in FIG. 6).

If the computer determines in step TS1 a possible collision during the engagement or during the separation between a tooth 22 of the first bevel gear 20 and a tooth 32 of the second bevel gear 30, the steps TS2 i. and TS2 ii. follow:
TS2 i. computer determination of a flank modification FM on the teeth 22 of the first bevel gear 20 or on the teeth 32 of the second bevel gear 30 to avoid the collision; and
TS2 ii. determination of second machine data MD2 on the basis of this flank modification FM.

The step TS2 i. can proceed from a computation approach in which, for example, the outlines of the second bevel gear 30 are statically defined in a coordinate system and in which, for example, the outlines of the first bevel gear 20 are moved relative to the second bevel gear 30 (for example, by a successive coordinate transformation). In most cases, both bevel gears 20, 30 have to be rotated, while the first bevel gear 20, for example, is axially displaced. The relative movement comprises a superposition of rotational and linear movements in these cases. A type of collision region in the three-dimensional coordinate system results due to this relative movement (which takes place by computer in a virtual sense here). This collision region may correspond to the penetration region of the volume body of the first bevel gear 20 with the volume body of the second bevel gear 30.

A flank modification FM of the tooth flanks of the teeth 22 of the first bevel gear 20 or the teeth 32 of the second bevel gear 30 can now be ascertained by computer on the basis of this penetration region.

The step TS2 ii. can establish the second machine data MD2 so that during the execution of the corresponding CNC-controlled movements in the bevel gear cutting machine 100, the required flank modification FM can be performed on the tooth flanks of the teeth 22 of the first bevel gear 20 or on the tooth flanks of the teeth 32 of the second bevel gear 30 by cutting machining.

If the computer determination in the step TS1 does not predict a collision, the retractability analysis ZV thus branches via an interface SS1 of FIG. 5 back to FIG. 4. In this case, the first or the second gearwheel 20 or 30, respectively, is produced without flank modification FM, and/or no finish machining is required in the bevel gear cutting machine 100 to perform a flank modification FM.

Before or during the method, a continuous indexing or discontinuous indexing gear cutting machining may be carried out in the bevel gear cutting machine 100, to provide the first bevel gear 20 or the second bevel gear 30 with gear teeth according to the first machine data MD1. It is not essential as to when this gear cutting machining is carried out.

As part of the some embodiments, a continuous indexing or a discontinuous indexing finish machining is carried out in the bevel gear cutting machine 100 to perform the flank modification FM according to the second machine data MD2 on the already provided teeth 22 of the first bevel gear 20 or on the already provided teeth 32 of the second bevel gear 30. This step of finish machining is carried out in any case after the original gear cutting of the corresponding bevel gear 20 or 30. This means the bevel gear 20 or 30 to be finish machined was already (previously) cut.

FIG. 6 shows a schematic block diagram of a (total) device 200.

The (total) device 200 comprises at least one CNC-controllable gear cutting machine 100 and a development environment 50, wherein the development environment 50 can have a communication connection 54 established with the gear cutting machine 100. This communication connection 54 is shown by a block arrow in FIG. 6. This can be, for example, a (company-internal) communication network, which connects the gear cutting machine 100 to the development environment 50.

The gear cutting machine 100 comprises a CNC-controller 101 and multiple CNC-controlled axes X, Y, Z, B, R1, R2 (the number of these CNC-controlled axes and the axis titles thereof are only to be understood as an example). In FIG. 6, each of the axes is shown by a block and each of these blocks is connected by a double arrow to the CNC controller 101. It is thus schematically indicated that the CNC controller 101 controls the individual axes, and the axes can transmit signals (for example, signals or data of path sensors or angle sensors) back to the CNC controller 101.

The gear cutting machine 101 can comprise an internal and/or external memory 102, as indicated in FIG. 6. The memory 102 can be connected via a communication connection 103 to the CNC controller 101. The memory 102 can optionally be loaded with data (for example, with the machine data MD1) via a further communication connection 104.

In order to be able to provide the first bevel gear 20 or the second bevel gear 30 with gear teeth on the basis of the first machine data MD1 in the scope of a continuous gear cutting procedure, the first machine data MD1 are loaded, for example, from the memory 102 via the communication connection 103 into the CNC controller 101, so that the CNC controller 101 can perform the cutting, continuous gear cutting machining on the corresponding bevel gear 20, 30 step-by-step. Such methods for gear cutting machining are well-known and will therefore not be explained in greater detail here.

The development environment 50 may be equipped with software SW1, which is designed for designing a transmission 10 having a first bevel gear 20 and a second bevel gear 30 to be paired therewith.

The development environment 50 can be equipped with means 55 for (manual) input of data D1. The data D1 can comprise, for example, the basic specifications required for a design method, which are required for the definition of a transmission 10.

From these data D1, the software SW1 can compute and provide design data AD1 for the first bevel gear 20 in the scope of a design procedure. These design data AD1 can either be converted in the development environment 50 into machine-specific machine data MD1, or this conversion is performed in the gear cutting machine 100 itself (by means of a software module SW2 therein, for example).

The development environment 50 may be designed for carrying out a retractability analysis ZV. For this purpose, the development environment 50 can comprise, for example, a software module ZV1, as indicated in FIG. 6. The software module ZV1 can provide modified design data AD1* and transmit these data to the gear cutting machine 100 for conversion into machine data MD2, or the software module ZV1 can provide machine data MD2, as shown on the basis of the example of FIG. 6. The provision of modified design data AD1* is not shown in FIG. 6.

The machine data MD1 and/or MD2 can be transferred by the software module SW2 to the memory 102, as schematically indicated by the communication connection 105, and/or the machine data MD1 and/or MD2 can be transferred directly (for example, by the development environment 50) to the CNC controller 101, or they can be transferred by the software module SW2 to the CNC controller 101, as schematically indicated by the communication connection 106.

The software module ZV1 can also be situated in a computer of the gear cutting machine 100. In this case, the mentioned development environment 50 is part of the machine 100.

The software module ZV1 may be designed for the purpose, in the scope of the above-mentioned retractability analysis ZV, to ascertain by computer a flank modification FM on teeth 22 of the first bevel gear 20 or the second bevel gear 30. This flank modification FM is ascertained so that a collision of the teeth 22 of the first bevel gear 20 with teeth 32 of the second bevel gear 30 during the installation or removal is avoided.

After the computer-based carrying out of the retractability analysis ZV, the second machine data MD2 (or in an alternative embodiment the modified design data AD1*) are provided directly or indirectly. These second machine data MD2 are defined so that they are usable in the gear cutting machine 100 for the CNC-controlled finish machining of the teeth 22 of the first bevel gear 20 or the teeth 32 of the second bevel gear 30.

The retractability analysis ZV may also consider information on the counter flank play during the ascertainment of the flank modification FM.

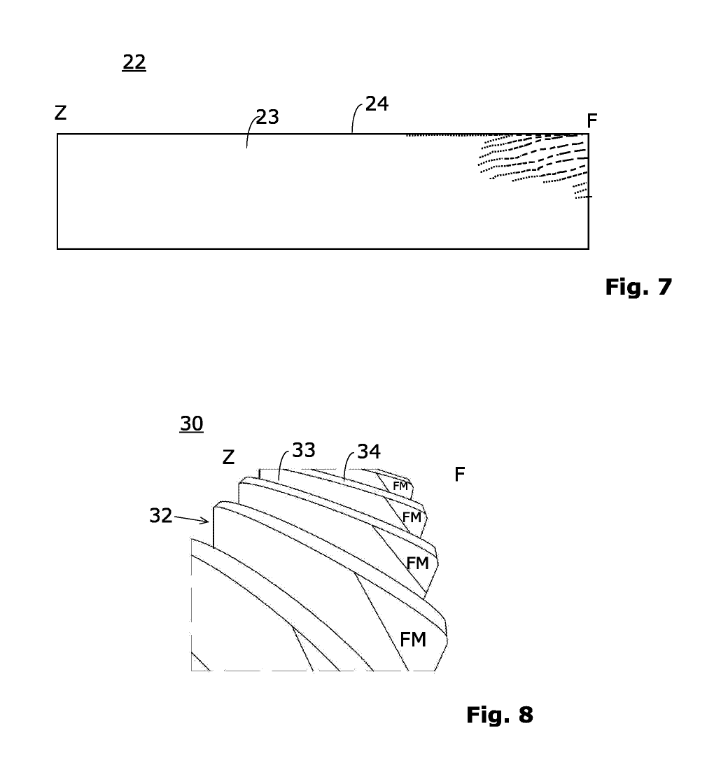

In FIG. 7, the tooth flank 23 of a tooth 22 of an exemplary first bevel gear 20 is shown in solely schematic form in a view in radial projection. The toe Z is shown on the left in FIG. 7 and the heel F of the first bevel gear 20 is shown on the right. The tooth head 24 is located on top and the tooth base on the bottom. In the right upper corner in the region of the heel, the result of a retractability analysis ZV carried out by computer is shown on the basis of multiple line trains. The smaller and finer the dots or strokes of the line trains are, the less strong is the penetration of the two volume bodies of the first bevel gear 20 and the second bevel gear 30. The longer the strokes of the line trains become, the stronger/deeper the penetration becomes.

The software module ZV1 can associate these line trains with a material removal. If one removes material, for example, on the tooth flanks 23 in accordance with the computed material removal in the scope of the finish machining, collision or jamming is then avoided during the axially oriented installation or removal.

To illustrate this on the basis of a concrete example, FIG. 8 shows the portion of a second bevel gear 30, the teeth 32 of which were provided with a flank modification FM. The toe Z is shown on the left in FIG. 8 and the heel F of the second bevel gear 30 is shown on the right. Flank modifications FM are provided on the concave tooth flanks 33 in the transition region between the tooth head 34 and the heel F.

As can be seen in FIG. 8, which shows the results of finish machining according to one embodiment, the penetration region is removed in a targeted and highly accurate manner by a cutting finish machining procedure by means of modified machine (setting) data (called second machine data MD2 here).

The simplest form of the finish machining results from a superposition of a crown wheel geometry previously generated in the plunging method with the original setpoint geometry of the tooth gaps. By suitable selection of the plunging position in conjunction with a workpiece wheel rotation adapted to the penetration depth, the “interfering” material component can be removed very exactly from the flanks 33 of the bevel gear 30.

Alternatively, a modified rolled geometry of the original geometry of the bevel gear can also be superimposed for the finish machining.

As may be recognized by those of ordinary skill in the pertinent art based on the teachings herein, numerous changes and modifications may be made to the above described and other embodiments of the present invention without departing from the spirit of the invention as defined in the claims. Accordingly, this detailed description of embodiments is to be taken in an illustrative, as opposed to a limiting sense.

1. A method for providing retractability of a first bevel gear defining a plurality of teeth configured to form a transmission with at least one second bevel gear defining a plurality of teeth, which is configured to be installed in a housing so that a rotational movement of the first bevel gear or the at least one second bevel gear is transferrable into a rotational movement of the other of the first bevel gear and the at least one second bevel gear, the method comprising:
(I) performing a retractability analysis including:
(A) determining with a computer whether one or more of (a) during said installation, the first bevel gear is engageable with the at least one second bevel gear via an axial insertion movement or (a) the first bevel gear is separable from engagement with the second bevel gear with via an axial retraction movement; and
(B) when the determining step predicts a collision during said engagement or during said separation between at least one tooth of the first bevel gear and at least one tooth of the at least one second bevel gear:
(i) determining with a computer a flank modification for said teeth of one or more of the first bevel gear or the at least one second bevel gear configured to prevent said collision; and
(ii) determining modified machine data based on said flank modification; and
(II) finish machining at least one of said teeth with a bevel gear cutting machine based on the modified machine data and, in turn, providing said flank modification thereon.

2. The method according to claim 1, further comprising, prior to step (I), generating design data for one or more of the first bevel gear or the at least one second bevel gear, and generating first machine data configured for preliminary machining of teeth of one or more of the first bevel gear or the at least one second bevel gear based on said design data.

3. The method according to claim 2, further comprising performing said preliminary machining with a bevel gear cutting machine based on the first machine data.

4. The method according to claim 2, including performing the step of generating design data in a development environment including software adapted for designing a transmission.

5. The method according to claim 4, further comprising loading the first machine data into a bevel gear cutting machine.

6. The method according to claim 1, including finish machining all of said teeth.

7. An apparatus comprising:
a CNC-controllable gear cutting machine including a CNC controller and a plurality of CNC-controlled axes, and configured to manufacture a bevel gear with a plurality of gear teeth according to machine data using a continuous gear cutting process; and
a development environment communicatingly connectable with the gear cutting machine and including software configured for designing a transmission having a first bevel gear and a second bevel gear configured to be paired therewith;
wherein the development environment is further configured to
generate design data for said transmission;
execute a retractability analysis including determining, by computer, a flank modification for teeth of one or more of the first bevel gear or the second bevel gear manufactured based on the design data configured to prevent collision of teeth of the first bevel gear with teeth of the second bevel gear during one or more of installation of the first bevel gear or the second bevel gear into the transmission or retraction of the first bevel gear or the second bevel gear from the transmission, and
generate machine data based on said flank modification and adapted for CNC-controlled finish machining of said teeth of one or more of the first bevel gear or the second bevel gear to provide said flank modification thereon.

8. The apparatus according to claim 7, wherein the gear cutting machine is a bevel gear milling machine or a bevel gear grinding machine.

9. A bevel gear transmission comprising:
a housing;
a first bevel gear including teeth; and
a second bevel gear including teeth;
wherein the first bevel gear and second bevel gear are engaged with one another, arranged at an angle with respect to one another, and rotatably mounted in the housing;
wherein the first bevel gear includes a flank modification on all right or on all left tooth flanks of said teeth thereof, or the second bevel gear includes a flank modification on all right or on all left tooth flanks of said teeth thereof; and
wherein said flank modification is configured to prevent collision of tooth flanks of the first bevel gear and tooth flanks of the second bevel gear during one or more of (i) installation of one or more of the first bevel gear or second bevel gear into the housing, or (ii) during removal of one or more of the first bevel gear or the second bevel gear from the housing.

10. The bevel gear transmission according to claim 9, wherein the second bevel gear defines a crown wheel, and the flank modification is located on all right or on all left tooth flanks thereof.

11. The bevel gear transmission according to claim 9, wherein each tooth flank including said flank modification defines a toe and a heel, and the flank modification is located closer to the heel than to the toe.
